(19) United States
(12) Patent Application Publication
(10) Pub. No.: US 2005/0260327 A1
(43) Pub. Date: Nov. 24, 2005

(54) Processed foods, and manufacturing system and manufacturing method for the processed foods

(76) Inventors: Katsuhiko Uwaya, Kofu-shi (JP); Koichi Shimaoka, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 11/131,206

(22) Filed: May 18, 2005

(30) Foreign Application Priority Data
May 20, 2004 (JP) 2004-151007

(51) Int. Cl. A23L 1/216

(52) U.S. Cl. 426/637

(57) ABSTRACT

The present invention provides processed foods that have not been deep-fried, are low in calories and well suited for maintaining health, and also can be diversified while being made uniform in product shape. The processed foods of the present invention are each formed as a product by dividing a paste-form material or lump-form material 5 obtained by mixing a dry raw material powder 1 consisting of a potato granules, and the like; an auxiliary raw material(s) or a seasoning(s) 2 selected from common salt, Umami seasonings, seaweeds, spices, sesames, cereals, nuts, fishery products, vegetables, and the like; and water 3 into individual chip-form materials 9, and baking each individual chip-form material 9 while sandwiching it.

### FIELD OF THE INVENTION

The present invention relates to processed foods, such as a potato chip and the like, a manufacturing system for the processed foods, and a manufacturing method for the processed foods.

### BACKGROUND OF THE INVENTION

Most of the conventional processed foods, such as a potato chip and the like, are formed as products by, for example, peeling of raw potatoes, slicing of peeled potatoes, deep-frying of sliced potatoes, and then seasoning of deep-fried potatoes.

In the case of such processed foods as a potato chip and the like, a deep-frying treatment is provided, thus the products contain oil components in quantity, are high in calories, present problems of health maintenance, due to the presence of cholesterol components, and the like, and thus have not always been desirable ones.

Patent Documents 1 proposes a snack food for which no deep-frying is carried out, although raw materials completely different from those of the present invention are used, and a method of manufacturing a snack food that is completely different from that of the present invention is employed.

Patent Documents 1

Patent Publication No. JP/P2000-253846A

The snack food disclosed in Patent Documents 1 is that obtained through a series of steps of peeling of white potatoes, pelletizing, steaming, drying, puffing, seasoning spraying, and drying (Means for Solving the Problem and FIG. 1 in Patent Documents 1).

However, in the case of the snack food of Patent Documents 1, raw white potatoes are used as a raw material, and pelletized for manufacturing the snack food, although the deep-frying step is not included, thus, the production cost is increased, and the product size and the product shape cannot be made uniform, resulting in products being non-uniform in size and shape. In addition, the snack food itself as a product has a finished shape which is substantially flat, and it is difficult to provide the snack food with a curved shape like a conventional potato chip, and the like.

### DISCLOSURE OF THE INVENTION

### PROBLEM TO BE SOLVED BY THE INVENTION

A problem to be solved by the present invention lies in that there is no processed food, such as a potato chip or the like, which has not been deep-fried, is low in calories and well suited for maintaining health, and also can be diversified while being made uniform in product shape.

### MEANS FOR SOLVING THE PROBLEM

The most important feature of the processed food of the present invention is that a chip-form material which is obtained by dividing a paste-form material (a material rendered pasty) or lump-form material, or otherwise a dough, produced by mixing a dry potato raw material powder, an auxiliary raw material(s) or a seasoning(s), and water into individual chip-form materials, is baked while being subjected to an appropriate pressure, sandwiched, to form a chip-form product.

### EFFECTS OF THE INVENTION

According to the present invention, the following effects are achieved.

According to the invention of claim 1 or 2, no deep-frying is performed, thus a processed food which contains no oil components like those of a potato chip subjected to a conventional deep-frying treatment, is low in calories and well suited for maintaining health, and uses potato granules, and the like as a main raw material can be provided.

According to the invention of claim 3, no deep-frying is performed, a processed food which contains no oil components like those of a potato chip subjected to a conventional deep-frying treatment, is low in calories and well suited for maintaining health, and has a curved-chip shape can be provided.

According to the invention of any of claims 4 to 7, the effects of each invention of the above-mentioned claims 1, 2, and 3 can be achieved while taking in the characteristic scheme of each of the inventions of said claims 4 to 7.

According to the invention of claim 8 or 9, a series of manufacturing steps which use means for forming a paste-form material or lump-form material, using potato granules, and the like as a main raw material, dividing means, and baking means, can be continuously and efficiently carried out for manufacturing a processed food which contains no oil components like those of a potato chip subjected to a conventional deep-frying treatment, and is low in calories and well suited for maintaining health.

According to the invention of claim 10, a system which additionally includes means for deformation heating can be used for manufacturing a processed food which contains no oil components like those of a potato chip subjected to a conventional deep-frying treatment, is low in calories and well suited for maintaining health, and has a curved shape.

According to the invention of any of claims 11 to 14, the effects of each invention of the above-mentioned claims 8, 9, and 10 can be achieved while taking in the characteristic scheme of each of the inventions of said claims 11 to 14.

According to the invention of claim 15 or 16, a mixing process which uses potato granules and the like as a main raw material for formation of a paste-form material or lump-form material, a dividing process for formation of individual chip-form materials, and a baking process can be continuously and efficiently carried out for manufacturing a processed food which contains no oil components like those of a potato chip subjected to a conventional deep-frying treatment, and is low in calories and well suited for maintaining health.

According to the invention of claim 17, a manufacturing process which additionally includes a process for deformation heating can be used for manufacturing a processed food which contains no oil components like those of a potato chip subjected to a conventional deep-frying treatment, is low in calories and well suited for maintaining health, and has a curved shape.

According to the invention of any of claims 18 to 21, the effects of each invention of the above-mentioned claims 15, 16, and 17 can be achieved while taking in the characteristic scheme of each of the inventions of said claims 18 to 21.

### BRIEF DESCRIPTION OF THE DRAWINGS

FIG. 1 is an explanatory view illustrating an outline of the manufacturing system and manufacturing process for processed foods of an embodiment of the present invention;

FIG. 2 is a perspective view illustrating an example of product obtained by an embodiment of the present invention;

FIG. 3 is a table giving an example of the properties of and the specifications for the potato granules and the like of an embodiment of the present invention;

FIG. 4 is an explanatory view illustrating an outline of the manufacturing system and manufacturing process for processed foods of an alternative embodiment of the present invention; and

FIG. 5 is a perspective view illustrating an example of product obtained by an alternative embodiment as shown in FIG. 4.

### BEST MODE FOR CARRYING OUT THE INVENTION

The purpose of providing processed foods which have not been deep-fried, are low in calories and well suited for maintaining health, and also can be diversified while being made uniform in product shape has been achieved by dividing a paste-form material or lump-form material obtained by mixing a dry raw material powder consisting of potato granules, and the like; an auxiliary raw material(s) or seasoning(s) selected from common salt, Umami seasonings, seaweeds, spices, sesames, cereals, nuts, fishery products, vegetables, and the like; and water into individual chip-form materials, baking each individual chip-form material while appropriately pressurizing and sandwiching it, and deformation heating it to form a product in the form of a curved chip.

### EMBODIMENTS

Hereinbelow, embodiments of the present invention will be described in detail.

A potato chip 20 as shown in FIG. 2, which is a processed food of the present embodiment, is a chip-form product of an appropriate size formed by dividing a paste-form material or lump-form material obtained by mixing a dry raw material powder (manufactured by Rixona, the Netherlands) consisting of potato granules, and the like; an auxiliary raw material(s) or seasoning(s) selected from common salt, Umami seasonings, seaweeds such as layer, spices, sesames, cereals such as germs, nuts such as peanut, fishery products such as shrimp, vegetables such as carrot, and the like; and water into individual chip-form materials, and baking each individual chip-form material while appropriately pressurizing and sandwiching it.

In the present embodiment, a dry raw material powder consisting of potato granules, and the like is used as a paste-form material or lump-form material, however, in the present invention, a raw material containing a dry powder or a substance in flake form of potato as an ingredient may be used as an alternative to the dry raw material powder consisting of potato granules, and the like.

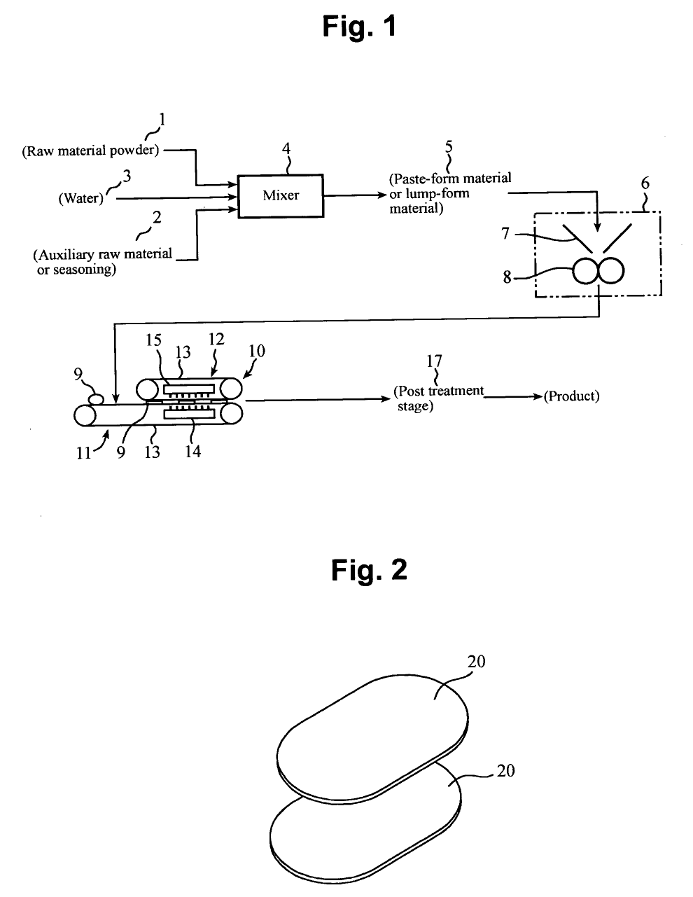

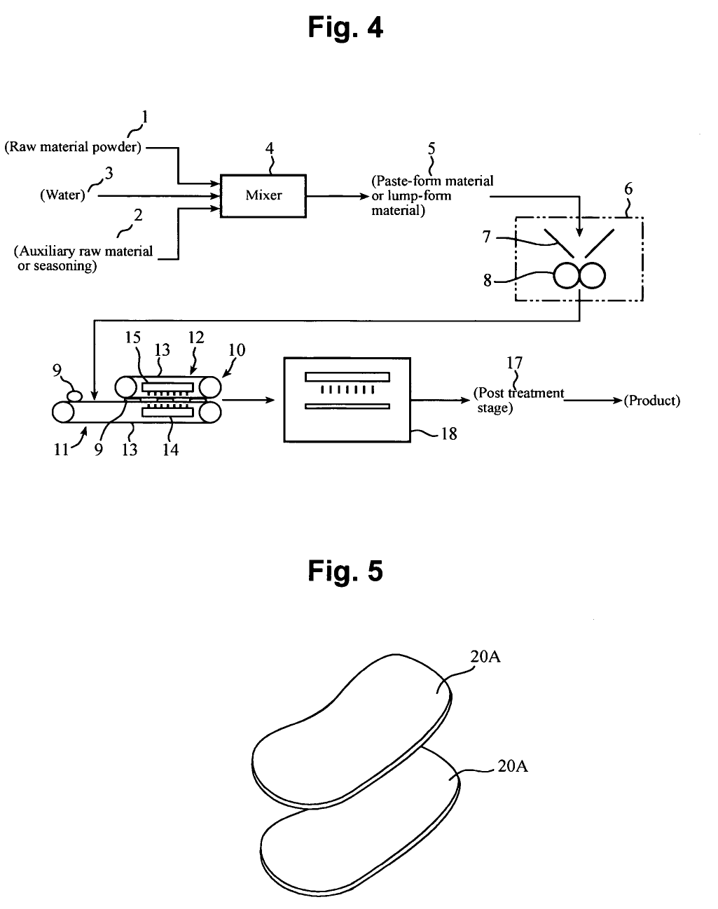

FIG. 1 and FIG. 4 show embodiments in which an auxiliary raw material(s) or seasoning(s) selected from common salt, Umami seasonings, seaweeds, spices, sesames, cereals, nuts, fishery products, vegetables, and the like is added to a dry raw material powder consisting of potato granules, and the like, and water, constituting a paste-form material or lump-form material of the potato chip 20, which is a processed food of the present embodiment, however, in the present invention, it is optional whether or not to add an auxiliary raw material(s) or seasoning(s) selected from common salt, Umami seasonings, seaweeds, spices, sesames, cereals, nuts, fishery products, vegetables, and the like, and a paste-form material or lump-form material of the potato chip 20, which is a processed food of the present embodiment, may be formed without the auxiliary raw material(s) or seasoning(s) being added.

The manufacturing system and manufacturing process for the potato chip 20 of the present embodiment will be described with reference to FIG. 1.

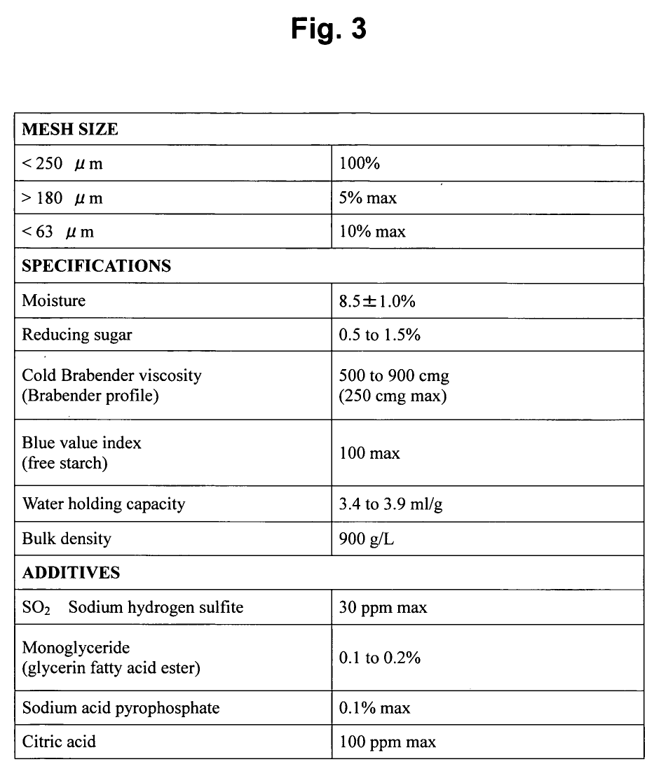

In the present embodiment, a dry raw material powder 1 consisting of potato granules, and the like, having the properties and meeting the specifications as given in FIG. 3; an auxiliary raw material(s) or seasoning(s) 2 selected from common salt, Umami seasonings, seaweeds, spices, sesames, cereals, nuts, fishery products, vegetables, and the like; and water 3 are prepared, charged into a mixing machine 4, and mixed to form a paste-form material or lump-form material 5.

Next, the obtained paste-form material or lump-form material 5 is placed in, for example, a squeezing machine 6 as dividing means having a hopper 7 and a squeezing roller 8, the paste-form material or lump-form material 5 is squeezed to be divided into individual chip-form materials 9.

In the example illustrated, the squeezing machine 6 is shown as that with a mechanism comprising a hopper 7 and a squeezing roller 8, however, in the present invention, the configuration of the squeezing machine is not limited to that of the example illustrated, but as a squeezing mechanism, a pump mechanism (not shown), for example, may be used for squeezing the paste-form material or lump-form material 5.

Next, each individual chip-form material 9 is fed to a sandwiching baking machine 10, which is baking means for baking while sandwiching the chip-form material 9.

In the present invention, the mechanism or method of the sandwiching baking machine is not limited to that of the respective embodiments illustrated, but it may be any mechanism or method, provided that it is a mechanism or method with which the chip-form material 9 is baked while being sandwiched from above and under, for instance, as in the example illustrated, or a mechanism or method with which said chip-form material 9 is heated to be baked while being sandwiched between thermally conductive plates.

The sandwiching baking machine 10 in the present embodiment illustrated conveys said chip-form material 9, while applying an appropriate pressure thereto, sandwiching it between a lower conveyor 11 and an upper conveyor 12 which, each having a conveying chain or conveying belt 13 at both ends, for example, are configured to turn, being supported by the conveying chains or conveying belts 13 at respective both ends, consisting, for example, of sheets made of iron or sheets made of a casting, or otherwise sheets made of copper, or the like that are rotatably formed; bakes both sides of the chip-form material 9 with flames and heat from a lower burner 14 and an upper burner 15; and conveys it out to the subsequent stage.

In the present invention, electric heaters may be used instead of the lower burner 14 and the upper burner 15 as shown in the drawing. In the present invention, although it is not shown, the sandwiching baking machine may also be configured to bake said chip-form material 9 while sandwiching it between a turntable and a vertically moving plate, wherein the turntable consists of a sheet made of iron or a sheet made of a casting, or otherwise a sheet made of copper, or the like adapted to rotate on a flat surface, and the vertically moving plate consists of a sheet made of iron or a sheet made of a casting, or otherwise a sheet made of copper, or the like that moves up and down above this turntable.

Further, as the best embodiment, the chip-form material 9 is sandwiched baked at a temperature of approx. 100° C. to 200° C. and a pressure of 0.5 to 5.0 kg/cm².

The chip-form material 9 conveyed out from said sandwiching baking machine 10 can be a potato chip 20 which is, for example, flat and rectangular or is in the shape of a thin, elliptical or circular disk as shown in FIG. 2, providing a product, as it is, or can also be a potato chip 20 which is flat and rectangular as shown in FIG. 2, providing a product seasoned by spraying a desired seasoning material(s), or the like, as required, at a post treatment stage 17.

Further, as the shape of the potato chip 20, a thin, circular disk, a thin, elliptical disk, a stick, and the like are also possible, as well as a rectangle.

In FIG. 3, the approximate properties of and specifications for said potato granules, and the like are given as an example; the mesh size of a dry powder of potato used as a main component being smaller than 250 μm, the values of moisture, reducing sugar, cold Brabender viscosity, blue value index, water holding capacity, and bulk density being as given in FIG. 3, and sodium hydrogen sulfite, monoglyceride, sodium acid pyrophosphate, citric acid, and the like being contained as additives.

According to the potato chip 20, which is a processed food obtained by the manufacturing system and manufacturing process for the potato chip 20 of the present embodiment, a dry powder of potato is used as a main component and no deep-frying process is provided, thus a health food that contains no oil components like those of a potato chip subjected to a conventional deep-frying treatment, and is low in calories and well suited for maintaining health can be produced.

According to the manufacturing system and manufacturing process for the potato chip 20 of the present embodiment, a series of manufacturing steps of generating a paste-form material or lump-form material 5 with a mixing machine 4, transforming it into individual chip-form materials 9 with a squeezing machine 6, and baking each individual chip-form material 9 to a potato chip 20 with a baking machine 10 while appropriately pressurizing and sandwiching it, can be continuously and efficiently carried out for manufacturing a potato chip 20 as a health food that contains no oil components like those of a potato chip subjected to a conventional deep-frying treatment manufactured, and is low in calories and well suited for maintaining health.

Next, an alternative embodiment of the present invention will be described with reference to FIG. 4 and FIG. 5.

This alternative embodiment is characterized in that, as deformation heating means for heating a chip-form material (a chip-form article) 9 to form a potato chip 20A, which is a product in the form of a curved chip (in curled form, twisted form, or the like), a gas oven 18 is inserted between the sandwiching baking machine 10 and the post treatment stage 17 in the manufacturing system and manufacturing process as shown in FIG. 1.

In the present invention, an electric heater, or the like may be used instead of the gas oven 18 as shown in the drawing.

According to the manufacturing system and manufacturing process of this alternative embodiment, properly setting the time period for baking both sides of the chip-form material 9 in said baking machine 10 while appropriately pressurizing and sandwiching it, and the time period for heating in the gas oven 18 makes it possible to manufacture a curved potato chip 20A (in a curled shape) as shown in FIG. 5.

The chip-form material 9 which is taken out from said gas oven 18 can be a potato chip 20A as shown in FIG. 5 that provides a product, as it is, or can also be a potato chip 20A in a curved shape as shown in FIG. 5 that provides a product seasoned by spraying a desired seasoning material(s), or the like, as required, at the post treatment stage 17.

According to the potato chip 20A, which is obtained by the manufacturing system and manufacturing process of this alternative embodiment, deep-frying is not performed, thus a health food which contains no oil components like those of a potato chip subjected to a conventional deep-frying treatment, is low in calories and well suited for maintaining health, and further has a curved shape different from that of said potato chip 20 can be produced.

According to the manufacturing system and manufacturing process for the potato chip 20A pertaining to this alternative embodiment, a series of manufacturing steps of generating a paste-form material or lump-form material 5 with a mixing machine 4, transforming it into individual chip-form materials 9 with a squeezing machine 6, baking each individual chip-form material 9 to a potato chip 20 with a baking machine 10, while appropriately pressurizing and sandwiching it, and deformation heating it with a gas oven 18 can be continuously and efficiently carried out for manufacturing a potato chip 20A in a curved shape as a health food that contains no oil components like those of a potato chip subjected to a conventional deep-frying treatment, and is low in calories and well suited for maintaining health.

As previously described, with the manufacturing system and manufacturing process for the potato chip 20A of this alternative embodiment, the mechanism or method of said sandwiching baking machine 10 is not limited to the example illustrated, but it may be any mechanism or method, provided that it is a mechanism or method with which the chip-form material 9 is baked while being sandwiched from above and under, for instance, as in the example illustrated, or a mechanism or method with which said chip-form material 9 is heated to be baked while being sandwiched between thermally conductive plates.

### INDUSTRIAL APPLICABILITY

The present invention is widely applicable to various processed foods made from such materials as root and tuber crops other than potato, corns, beans, and the like, and as manufacturing means therefor, as well as being applied to the above-mentioned potato chips and as manufacturing means therefor.

1. A processed food, wherein a chip-form material which is obtained by dividing a paste-form material or lump-form material produced by mixing a dry potato raw material powder and water into individual chip-form materials, is baked while being sandwiched, to form a chip-form product.

2. A processed food, wherein a paste-form material or lump-form material obtained by mixing a dry potato raw material powder consisting of potato granules, and the like, and water is divided into individual chip-form materials, and this chip-form material is baked while being sandwiched, to form a chip-form product.

3. A processed food, wherein a paste-form material or lump-form material obtained by mixing a dry potato raw material powder consisting of potato granules, and the like, and water is divided into individual chip-form materials, and this chip-form material is baked, while being sandwiched, and subjected to deformation heating to form a product in the form of a curved chip.

4. The processed food of claim 1, wherein said paste-form material or lump-form material contains an auxiliary raw material(s) or a seasoning(s) selected from common salt, Umami seasonings, seaweeds, spices, sesames, cereals, nuts, fishery products, vegetables, and the like.

5. The processed food of claim 1, wherein said baking while sandwiching involves pressurizing in the baking.

6. The processed food of claim 1, wherein the mechanism for said baking while sandwiching is configured such that said chip-form material is heated to be baked while being sandwiched from above and under.

7. The processed food of claim 1, wherein the mechanism for said baking while sandwiching is configured such that said chip-form material is heated to be baked while being sandwiched between thermally conductive plates.

8. A manufacturing system for processed foods, comprising:
means for mixing a dry potato raw material powder and water for preparation of a paste-form material or lump-form material;
means for squeezing the paste-form material or lump-form material for division thereof into individual chip-form materials; and
means for baking each individual chip-form material while sandwiching it to form a chip-form product.

9. A manufacturing system for processed foods, comprising:
means for mixing a dry potato raw material powder consisting of potato granules, and the like, and water for preparation of a paste-form material or lump-form material;
dividing means for squeezing the paste-form material or lump-form material for division thereof into individual chip-form materials; and
baking means for baking each individual chip-form material while sandwiching it to form a chip-form product.

10. A manufacturing system for processed foods, comprising:
means for mixing a dry potato raw material powder consisting of potato granules, and the like, and water for preparation of a paste-form material or lump-form material;
dividing means for squeezing the paste-form material or lump-form material for division thereof into individual chip-form materials;
baking means for baking each individual chip-form material while sandwiching it to form a chip-form article; and
deformation heating means for heating the chip-form article to form a product in the form of a curved chip.

11. The manufacturing system for processed foods of claim 8, wherein said paste-form material or lump-form material contains an auxiliary raw material(s) or a seasoning(s) selected from common salt, Umami seasonings, seaweeds, spices, sesames, cereals, nuts, fishery products, vegetables, and the like.

12. The manufacturing system for processed foods of claim 8, wherein said baking while sandwiching involves pressurizing in the baking.

13. The manufacturing system for processed foods of claim 8, wherein the mechanism for said baking while sandwiching is configured such that said chip-form material is heated to be baked while being sandwiched from above and under.

14. The manufacturing system for processed foods of claim 8, wherein the mechanism for said baking while sandwiching is configured such that said chip-form material is heated to be baked while being sandwiched between thermally conductive plates.

15. A manufacturing method for processed foods, comprising the steps of:
mixing a dry potato raw material powder and water for preparation of a paste-form material or lump-form material;
squeezing the paste-form material or lump-form material for division thereof into individual chip-form materials; and
baking each individual chip-form material while sandwiching it to form a chip-form product.

16. A manufacturing method for processed foods, comprising the steps of:
mixing a dry potato raw material powder consisting of granules, and the like, and water for preparation of a paste-form material or lump-form material;
squeezing the paste-form material or lump-form material for division thereof into individual chip-form materials; and
baking each individual chip-form material while sandwiching it to form a chip-form product.

17. A manufacturing method for processed foods, comprising the steps of:
mixing a dry potato raw material powder consisting of granules, and the like, and water for preparation of a paste-form material or lump-form material;
squeezing the paste-form material or lump-form material for division thereof into individual chip-form materials;
baking each individual chip-form material while sandwiching it to form a chip-form article; and
deformation heating the chip-form article to form a product in the form of a curved chip.

18. The manufacturing method for processed foods of claim 15, wherein said paste-form material or lump-form material contains an auxiliary raw material(s) or a seasoning(s) selected from common salt, Umami seasonings, seaweeds, spices, sesames, cereals, nuts, fishery products, vegetables, and the like.

19. The manufacturing method for processed foods of claim 15, wherein said baking while sandwiching involves pressurizing in the baking.

20. The manufacturing system for processed foods of claim 15, wherein the mechanism for said baking while sandwiching is configured such that said chip-form material is heated to be baked while being sandwiched from above and under.

21. The manufacturing system for processed foods of claim 15, wherein the mechanism for said baking while sandwiching is configured such that said chip-form material is heated to be baked while being sandwiched between thermally conductive plates.

22. The processed food of claim 2, wherein said paste-form material or lump-form material contains an auxiliary raw material(s) or a seasoning(s) selected from common salt, Umami seasonings, seaweeds, spices, sesames, cereals, nuts, fishery products, vegetables, and the like.

23. The processed food of claim 3, wherein said paste-form material or lump-form material contains an auxiliary raw material(s) or a seasoning(s) selected from common salt, Umami seasonings, seaweeds, spices, sesames, cereals, nuts, fishery products, vegetables, and the like.

24. The processed food of claim 2, wherein said baking while sandwiching involves pressurizing in the baking.

25. The processed food of claim 3, wherein said baking while sandwiching involves pressurizing in the baking.

26. The processed food of claim 2, wherein the mechanism for said baking while sandwiching is configured such that said chip-form material is heated to be baked while being sandwiched from above and under.

27. The processed food of claim 3, wherein the mechanism for said baking while sandwiching is configured such that said chip-form material is heated to be baked while being sandwiched from above and under.

28. The processed food of claim 2, wherein the mechanism for said baking while sandwiching is configured such that said chip-form material is heated to be baked while being sandwiched between thermally conductive plates.

29. The processed food of claim 3, wherein the mechanism for said baking while sandwiching is configured such that said chip-form material is heated to be baked while being sandwiched between thermally conductive plates.

30. The manufacturing system for processed foods of claim 9, wherein said paste-form material or lump-form material contains an auxiliary raw material(s) or a seasoning(s) selected from common salt, Umami seasonings, seaweeds, spices, sesames, cereals, nuts, fishery products, vegetables, and the like.

31. The manufacturing system for processed foods of claim 10, wherein said paste-form material or lump-form material contains an auxiliary raw material(s) or a seasoning(s) selected from common salt, Umami seasonings, seaweeds, spices, sesames, cereals, nuts, fishery products, vegetables, and the like.

32. The manufacturing system for processed foods of claim 9, wherein said baking while sandwiching involves pressurizing in the baking.

33. The manufacturing system for processed foods of claim 10, wherein said baking while sandwiching involves pressurizing in the baking.

34. The manufacturing system for processed foods of claim 9, wherein the mechanism for said baking while sandwiching is configured such that said chip-form material is heated to be baked while being sandwiched from above and under.

35. The manufacturing system for processed foods of claim 10, wherein the mechanism for said baking while sandwiching is configured such that said chip-form material is heated to be baked while being sandwiched from above and under.

36. The manufacturing system for processed foods of claim 9, wherein the mechanism for said baking while sandwiching is configured such that said chip-form material is heated to be baked while being sandwiched between thermally conductive plates.

37. The manufacturing system for processed foods of claim 10, wherein the mechanism for said baking while sandwiching is configured such that said chip-form material is heated to be baked while being sandwiched between thermally conductive plates.

38. The manufacturing method for processed foods of claim 16, wherein said paste-form material or lump-form material contains an auxiliary raw material(s) or a seasoning(s) selected from common salt, Umami seasonings, seaweeds, spices, sesames, cereals, nuts, fishery products, vegetables, and the like.

39. The manufacturing method for processed foods of claim 17, wherein said paste-form material or lump-form material contains an auxiliary raw material(s) or a seasoning(s) selected from common salt, Umami seasonings, seaweeds, spices, sesames, cereals, nuts, fishery products, vegetables, and the like.

40. The manufacturing method for processed foods of claim 16, wherein said baking while sandwiching involves pressurizing in the baking.

41. The manufacturing method for processed foods of claim 17, wherein said baking while sandwiching involves pressurizing in the baking.

42. The manufacturing system for processed foods of claim 16, wherein the mechanism for said baking while sandwiching is configured such that said chip-form material is heated to be baked while being sandwiched from above and under.

43. The manufacturing system for processed foods of claim 17, wherein the mechanism for said baking while sandwiching is configured such that said chip-form material is heated to be baked while being sandwiched from above and under.

44. The manufacturing system for processed foods of claim 16, wherein the mechanism for said baking while sandwiching is configured such that said chip-form material is heated to be baked while being sandwiched between thermally conductive plates.

45. The manufacturing system for processed foods of claim 17, wherein the mechanism for said baking while sandwiching is configured such that said chip-form material is heated to be baked while being sandwiched between thermally conductive plates.
